(19) United States
(12) Patent Application Publication
(10) Pub. No.: US 2026/0052367 A1
(43) Pub. Date: Feb. 19, 2026

(54) ENHANCED EMERGENCY NOTIFICATION SYSTEM

(71) Applicant: T-MOBILE INNOVATIONS LLC, Overland Park, KS (US)

(72) Inventor: Paul Marvin CHY, Snohomish, WA (US)

(21) Appl. No.: 18/806,407

(22) Filed: Aug. 15, 2024

(51) Int. Cl. H04W 4/90

(52) U.S. Cl. CPC H04W 4/90

(57) ABSTRACT

Embodiments of the present disclosure are directed to systems and methods for alerting user devices of anomalous behavior of user equipment (UE) within a wireless communication system. In order to alert users of natural disasters associated with the anomalous behavior and enable them to take appropriate actions such as evacuating or sheltering in place, a pattern of a number of internet of things (IoT) devices and UEs (e.g., smart phones) disconnecting from a network is detected, a cone of uncertainty (e.g., the direction that the natural disaster is likely to continue in) is inferred from that pattern, and people within the cone of uncertainty are warned that they may be in danger of an approaching natural disaster.

### SUMMARY

The present disclosure is directed to alerting user devices of anomalous behavior of user equipment (UE) within a wireless communication system, substantially as shown and/or described in connection with at least one of the Figures, and as set forth more completely in the claims.

According to various aspects of the technology, a pattern of a number of internet of things (IoT) devices and UEs (e.g., smart phones) disconnecting from a network is detected, a cone of uncertainty (e.g., the direction that the pattern is likely to continue in) is inferred from that pattern, and people within the cone of uncertainty are warned that they may be in danger of an approaching natural disaster. In order to accomplish this, IoT devices and UEs are deployed and/or located in a region. These devices are connected by a network. When the devices lose connection to the network, an artificial intelligence (AI) (e.g., a machine learning model) can detect a pattern of anomalous behaviors which comprises the disconnections between the devices and the network. The pattern of anomalous behavior is used by the AI to determine a cone of uncertainty, which is a predicted impact zone of the natural disaster. Users within the cone of uncertainty are then alerted that they may be in danger, enabling them to take appropriate actions such as evacuating or sheltering in place. By alerting the people residing within the cone of uncertainty that they may be in immediate danger (e.g., within the path of a natural disaster), these people may be able to take immediate action to ensure their safety.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates a computing device for use with the present disclosure;

FIG. 2 illustrates a network environment in which implementations of the present disclosure may be employed;

FIG. 3 illustrates a predicted impact zone for in which implementations of the present disclosure may be employed; and

FIG. 4 depicts a flow diagram of a method in accordance with embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like. The term “mmWave” means RF waves having a wavelength measured in millimeters or fractions of millimeters (i.e., less than one cm), generally in the range of 30 GHz-3 THz, though frequencies above and below that range may still be used by aspects of the present disclosure.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, natural disasters may cause significant harm to property and human lives. Natural disasters, such as earthquakes and hurricanes, often result in destruction of homes and infrastructure, economic setbacks, displacement of people, and loss of life. For example, a tornado may tear through a town and destroy anything that lies in its path. Furthermore, natural disasters may disrupt essential services like electricity, water supply, and transportation, leading to further challenges for affected communities. As such, natural disasters often affect the ability of people to continue with their regular daily routines.

Conventionally, people are warned about natural disasters by various means, including early warning systems, sirens, broadcast alerts, and social media notifications. Governments and relevant organizations often monitor weather patterns, seismic activity, and other indicators to detect potential disasters and issue warnings to the public. Despite monitoring attempts, natural disasters can occur with insufficient warning and may leave people vulnerable to the hazardous conditions. People residing in the direction of the hazardous condition (e.g., tornado, earthquake, landslide, hurricane, etc.) are often notified too late that they are in potential danger. Consequently, conventional solutions aimed at warning people of natural disasters may be improved with a more robust method of alerting people of natural disasters.

Unlike conventional solutions, the present disclosure is directed to detecting a pattern of internet of things (IoT) devices and UEs (e.g., smart phones) disconnecting from a network, inferring a cone of uncertainty (e.g., the direction that the pattern is likely to continue in) from that pattern, and warning people within the cone of uncertainty that they may be in danger. In order to accomplish this, IoT devices and UEs are deployed and/or located in a region. These devices (e.g., IoT and UE) are connected by a network. When the devices lose connection to the network, an artificial intelligence (AI) (e.g., a machine learning model) can detect a pattern of anomalous behaviors (e.g., disconnects between devices) and determine the cone of uncertainty (e.g., a predicted future impact zone). Users within the cone of uncertainty are then alerted that they may be in danger, enabling them to take appropriate actions such as evacuating or sheltering in place.

Accordingly, a first aspect of the present disclosure is directed to a system for alerting user devices of anomalous behavior of user equipment (UE) within a wireless communication system. The system comprises one or more antenna elements configured to transmit one or more downlink signals from a base station to one or more UEs located in a geographic coverage area. The system further comprises one or more computer processing components configured to perform operations comprising detecting a plurality of devices disconnecting from a telecommunication network. The operations further comprise determining that the disconnections form an impact pattern associated with one or more hazardous conditions. The operations further comprise generating a predicted impact zone based on the impact pattern and associated with future movement of the one or more hazardous conditions. The operations further comprise communicating an alert to one or more user devices located in the predicted impact zone.

A second aspect of the present disclosure is directed to a method for alerting user devices of anomalous behavior of user equipment (UE) within a wireless communication system. The method comprises detecting a plurality of devices disconnecting from a telecommunication network. The method further comprises determining that the disconnections form an impact pattern associated with one or more hazardous conditions. The method further comprises generating a predicted impact zone based on the impact pattern and associated with future movement of the one or more hazardous conditions. The method further comprises communicating an alert to one or more user devices located in the predicted impact zone.

Another aspect of the present disclosure is directed to a non-transitory computer readable media having instructions stored thereon that, when executed by one or more computer processing components, cause the one or more computer processing components to perform a method for alerting user devices of anomalous behavior of user equipment (UE) within a wireless communication system. The method comprises detecting a pattern comprising a plurality of devices disconnecting from a telecommunication network. The method further comprises determining that the disconnections form an impact pattern associated with one or more hazardous conditions. The method further comprises generating a predicted impact zone based on the impact pattern and associated with future movement of the one or more hazardous conditions. The method further comprises communicating an alert to one or more user devices located in the predicted impact zone.

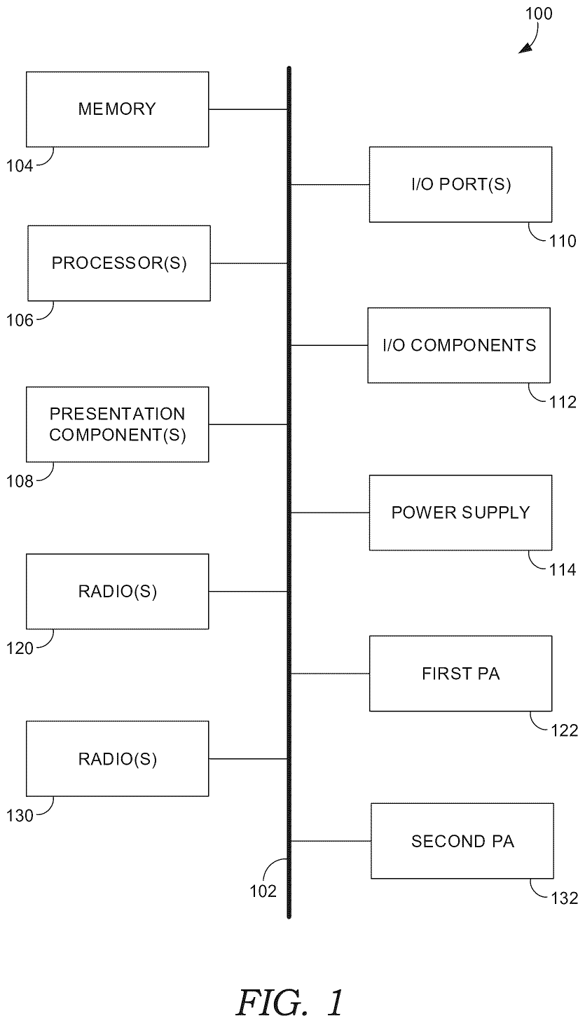

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device. The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and a second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, 802.11, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VoLTE, or other VOIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may configured to communicate with one or more other computing devices according to a local area communication protocol (e.g., IEEE 802.11 series, Bluetooth, NFC, z-wave, or the like).

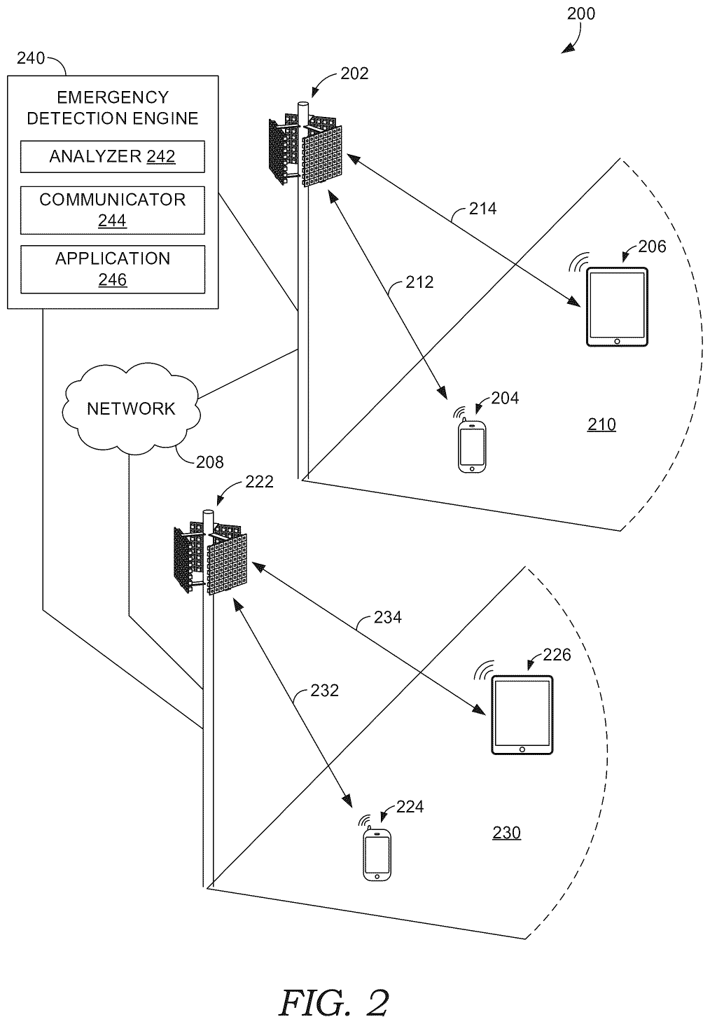

Turning now to FIG. 2, an exemplary network environment is illustrated in which implementations of the present disclosure may be employed. Such a network environment is illustrated and designated generally as network environment 200. At a high level, the network environment 200 comprises one or more UEs, one or more IoT devices, one or more base stations, and one or more networks. Though each of a first UE 204 and a second UE 224 are illustrated as cellular phones, a UE suitable for implementations with the present disclosure may be any computing device having any one or more aspects described with respect to FIG. 1. Similarly, though each of a base station 202 and a base station 222 are illustrated as a macro cell on a cell tower, any scale or form of access point acting as a transceiver station for wirelessly communicating with a UE, including small cells, pico cells, Wi-Fi access points (e.g., routers or mesh networks), and the like, are suitable for use with the present disclosure. Furthermore, though each of an IoT device 206 and an IoT device 226 are illustrated as tablets, an IoT suitable for implementations with the present disclosure may be any computing device having any one or more aspects described with respect to FIG. 1.

The network environment 200 comprises one or more base stations with which a UE may wirelessly communicate. The base station 202 comprises hardware and software components that allow it to wirelessly communicate with one or more UEs in one or more coverage areas. Each coverage area may be logically defined in space and frequency as one or more cells, which may or may not overlap. An example of such a cell is cell 210, in which the base station 202 is configured to wirelessly communicate with the first UE 204 using a first wireless connection 212 and the IoT device 206 using a second wireless connection 214. Another example of such a cell is cell 230, in which the base station 222 is configured to wirelessly communicate with the second UE 224 using a third wireless connection 232 and the IoT device 226 using a fourth wireless connection 234. Using any radio access technology selected by a mobile network operator (e.g., 4G, 5G, 6G, 802.11x, and the like), the base station may transmit and receive wireless signals using one or more antenna elements.

Each base station of the one or more base stations may be associated with one or more at least partially distinct networks, wherein each network is associated with one or more network identifiers. Each network may be a telecommunications network(s) (e.g., a packet data network or core network), data network, or portions thereof. A telecommunications network that at least partially comprises the network environment 200 may include additional devices or components (e.g., one or more base stations) not shown. Those devices or components may form network environments similar to what is shown in FIG. 2, and may also perform methods in accordance with the present disclosure. Components such as terminals, links, and nodes (as well as other components) may provide connectivity in various implementations.

In order to alert user devices of anomalous behavior of UEs within a wireless communication system, the network environment comprises an emergency detection engine 240. Though illustrated as a dedicated engine comprising three discrete modules, the emergency detection engine 240 and its modules are described herein by way of their functionality and may be deployed or implemented in various ways that are consistent with the functionality described herein. The emergency detection engine 240 may be said to comprise an analyzer 242, a communicator 244, and an application 246. In a first embodiment, the emergency detection engine 240 may take the form of one or more computer processing components at or near the base station 202 (or the base station 222) executing computer executable instructions that cause the one or more computer processing components to perform the operations described herein. In a second embodiment, the emergency detection engine 240 may be implemented at a UE and/or an IoT device to perform the operations described herein. In a third embodiment, a cloud storage provider and/or a data repository provider to which UEs and/or IoT devices report to may use and/or implement the emergency detection engine 240 to perform the operations described herein.

The analyzer 242 is configured to analyze the behavior of user devices (e.g., first UE 204 and second UE 224) and IoT devices (e.g., IoT device 206 and IoT device 226) located in one or more cells (e.g., cell 210 and cell 230). Relevant to the present disclosure, the behavior of the user devices and the IoT devices comprises an active connection to a telecommunication network (e.g., network 208). The analyzer 242 monitors the active connections to and disconnections from a telecommunication network. In some examples, when user devices and IoT devices normally comprise an active connection with a network (e.g., connections 212, 214, 232, and 234, for example), then these typically active connections suddenly disconnect from the network, the analyzer may detect a pattern of anomalous behavior, the pattern comprising a number of devices disconnecting from the telecommunication network.

In some aspects, the analyzer 242 is a type of artificial intelligence (e.g., a machine learning model) that detects the pattern of anomalous behavior. In such an example, the analyzer 242 may use machine learning capabilities to detect the pattern of user devices and IoT devices abnormally disconnecting from a telecommunications network when these devices are normally connected to the telecommunications network. In some examples, the analyzer 242 may be any system (e.g., manually operated or facilitated by computer operations) that is capable of detecting a pattern of anomalous behavior in a geographic coverage area, specifically a pattern of a number of devices disconnecting from a telecommunication network.

The analyzer 242 is generally configured to determine that the disconnections form an impact pattern associated with one or more hazardous conditions. For example, the analyzer 242 may determine that the disconnections from the telecommunication network are the result of a land slide tumbling through a neighborhood where user devices and IoT devices are located within homes affected by the landslide. Continuing that example, the analyzer 242 may determine that the disconnections of the user devices and the IoT devices form an impact pattern associated with the land slide (e.g., homes, along with the user devices and/or IoT devices located therein, were damaged or destroyed in the land slide).

In some aspects, in addition to monitoring the connections and disconnections of user devices and IoT devices from a network, the analyzer 242 may also monitor geographic, weather, and sensor data to more accurately determine what type of hazardous condition is associated with the impact pattern. For example, sensor data may include data captured by sensors that is associated with a geographic region or physical location of the sensors. As such, sensor data may include visual data, olfactory data, audible data, haptic data, temporal data, temperature data, atmospheric pressure data, humidity data, and any other type of data that can be associated with a surrounding environment (e.g., environmental data). Sensor data may further include environmental data such as, for example, measurements of ambient temperature, sounds, visuals, smells, moisture, altitude, and the like. For example, sensor data may include data associated with the weather of any given region. As such, the analyzer 242 may monitor weather data, which may comprise feeds or inputs from weather services, weather radars, emergency or severe weather alerts, and the like, in order to corroborate or associate the pattern of disconnections with the hazardous condition. The analyzer 242 may monitor geographic data, which may comprise data associated with a geographic region, seismic activity in a geographic region, topography of a geographic region, and any other type of data associated with a geographic region. The sensor(s) capturing the geographic and sensor data may be integrated by a user device or an IoT device, may be physically proximate to the user device or an IoT device so as to communicate with the in-range user device or IoT device, and/or any combination thereof. Accordingly, the analyzer 242 may monitor geographic, weather, and sensor data, in addition to monitoring disconnections of user devices and IoT devices from a network, to determine what type of hazardous condition (e.g., determined from analyzing the geographic and sensor data) could be associated with an impact pattern.

In some aspects, the analyzer 242 uses the geographic and sensor data, as well as the impact pattern, as inputs to output a predicted impact zone, which is the potential continued geographic path of a natural disaster. In other words, the analyzer 242 may generate a predicted impact zone based on the impact pattern associated with future movement of a hazardous condition. For example, the analyzer 242 may be an AI (e.g., a machine learning model) that generates a predicted impact zone associated with future movement of a hurricane based on the detected pattern of anomalous behavior. The predicted impact zone may be thought of as a cone of uncertainty in which the hazardous condition is likely to continue traversing in any direction within the cone. As such, the predicted impact zone may delineate the geographic region in which the hazardous condition (e.g., a natural disaster such as a landslide, hurricane, tornado, etc.) may potentially move to next.

The communicator 244 is configured to receive the data associated with a predicted impact zone from the analyzer 242. In some aspects, the communicator 244 is generally configured to communicate an alert to user devices and/or IoT devices located in the predicted impact zone. For example, the communicator 244 may send packet data containing information about the alert to base stations (e.g., base station 202 and base station 222) of a telecommunications network (e.g., network 208). The base stations, having received the information from the communicator 244, may send an alert to devices located within a predicted impact zone to warn users that they may be in immediate danger. In some examples, the communicator 244 may identify UEs and IoT devices located inside the predicted impact zone and send an alert to those devices. In some aspects, the communicator 244 may identify cells within the predicted impact zone and push an alert to the UEs and IoT devices located within those cells. For example, the communicator 244 may send an alert to the UEs and IoT devices located within a cell within the predicted impact zone even if the cell partially overlaps the impact zone. In some embodiments, the communicator 244 may identify a base station that at least partially serves an area that overlaps with the predicted impact zone, and the communicator 244 may send an alert to any UE and/or IoT device connected to such a base station.

The application 246 is configured to facilitate the mode in which the alert is communicated to devices located within a predicated impact zone. For example, the application 246 may be configured to communicate an alert regarding the hazardous condition or event by communicating the alert in a mode that is sensible to a user, based on user preferences that are configurable by the user. In some examples, the alert can be sent in the form of a push notification to a UE or an IoT device located in the predicted impact zone. In some aspects, the alert can be communicated to a UE or an IoT device in the form of an SMS. In some aspects, a voice call can be a mode in which an alert is communicated to one or more user devices located in the predicted impact zone. In some examples, receiving the alert at a user device (e.g., a UE or IoT device) can cause the user device to perform an action without a user. For example, many UEs and IoT devices (e.g., smart homes, for example) could be caused to execute abnormal actions and/or alert-specific actions. In some examples, abnormal actions may include causing lights on a user device to flash on and off or causing a television to turn on without instruction. In some examples, alert-specific actions may include causing a television to turn on and/or change the channel to the local news station to monitor an emergency; displaying a visual alert on a connected device (e.g., IoT device) with a screen (e.g., a television, tablet, etc.); or causing an audible alert or emergency tone to be played on a connected audio device (e.g., a digital assistant device, smart speaker, etc.) that can be used to either get a user's attention or actually convey emergency information. In some examples, a user can acknowledge the having received the alert through the application 246. In some aspects, when an alert is not acknowledged within a threshold time period, the application 246 may determine that a new alert should be communicated, and the communicator 244 may recommunicate the alert to the user device that has not acknowledged the alert.

In embodiments wherein the emergency detection engine 240 is implemented by a UE and/or an IoT device, the UE and/or IoT device may utilize the emergency detection engine 240 to perform the functions described herein. For example, a UE and/or IoT device may utilize the emergency detection engine 240 to analyze neighboring device data, geographic data, weather data, and sensor data. Continuing the example, the UE may utilize the emergency detection engine 240 to periodically check on the status of one or more nearby devices (e.g., for a period of time that is determinable and changeable by a user). In this example, the UE and all of the other nearby UEs may report its status (e.g., its connection to a network) to some cloud storage or data repository every predetermined time period, and a target UE (e.g., a UE capable of performing functions described herein) may utilize the emergency detection engine 240 to query the cloud storage or data repository every predetermined time period. By doing this, the target UE may be able to, via the emergency detection engine 240, detect nearby devices in a geographic coverage area disconnecting from a telecommunication network, determine that the disconnections form an impact pattern associated with one or more hazardous conditions, and generate a predicted impact zone based on the impact pattern. Accordingly, the UE may communicate an alert to neighboring devices within the predicted impact zone. In this example, the target UE and the nearby UEs may be proprietary devices, which may include, but are not limited to, smart lightbulbs, smart home devices, speakers, headphones, watches, and/or any other UE or IoT device as described herein.

In embodiments wherein the emergency detection engine 240 is implemented by a cloud storage provider and/or a data repository provider to which UEs and/or IoT devices report to (e.g., send data to), the cloud storage provider and/or the data repository provider may perform the functions described herein. For example, the cloud storage provider and/or the data repository provider may utilize the emergency detection engine 240 to analyze all of the devices in a geographic region that report to the cloud storage provider and/or the data repository provider, as well as geographic data, weather data, and sensor data. Continuing the example, the cloud storage provider and/or the data repository provider may utilize the emergency detection engine 240 to periodically check on the status of the devices in a geographic region that utilize the services of the cloud storage and/or data repository. In this example, the devices utilizing the services of the providers may report their status (e.g., its connection to a network) to the cloud storage or data repository every predetermined time period, and the cloud storage provider and/or the data repository provider may utilize the emergency detection engine 240 to query the cloud storage or data repository every predetermined time period. By doing this, the cloud storage provider and/or the data repository provider may be able to, via the emergency detection engine 240, detect nearby devices in a geographic coverage area disconnecting from a telecommunication network, determine that the disconnections form an impact pattern associated with one or more hazardous conditions, and generate a predicted impact zone based on the impact pattern. Accordingly, the cloud storage provider and/or the data repository provider may communicate an alert to neighboring devices within the predicted impact zone. In this example, the cloud storage provider and/or the data repository provider may include, but are not limited to, major multination technology companies, data providers, and/or any other cloud storage/service providers.

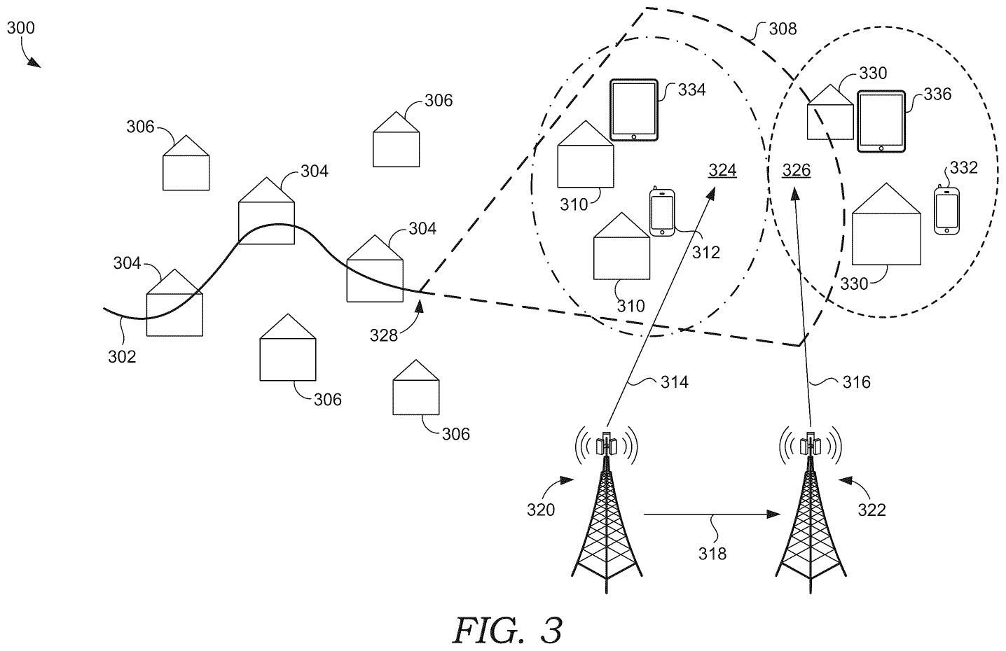

Turning now to FIG. 3, an example of the enhanced emergency notification system 300 is provided. The enhanced emergency notification system visually illustrates communicating an alert to user devices within a predicted impact zone (e.g., cone of uncertainty). For example, a pattern of anomalous behavior in a geographic coverage area is illustrated in FIG. 3, and the pattern includes a number of devices disconnecting from a telecommunication network. In the example illustrated in FIG. 3, the pattern goes through three affected homes 304. This pattern was determined by the analyzer 242 of FIG. 2 to be an impact pattern 302 associated with one or more hazardous conditions, such as a tornado, based on the disconnections of user devices from a network and additionally based on sensor and geographic data. As can be seen in the example illustrated in FIG. 3, safe homes 306 are not located in the impact pattern. Because no anomalous behavior was detected, the safe home 306 are deemed to be outside the impact pattern 302.

Based on the disconnections of user devices from a network in addition to the sensor and geographic data, the analyzer 242 of FIG. 2 may generate the predicted impact zone 308. The predicted impact zone 308 begins at divergence point 328. Divergence point 328 is the point at which the analyzer 242 does not have any new data associated with disconnections from networks and/or sensor or geographic data. As such, the divergence point 328 is the end of the impact pattern 302 and the beginning of the predicted impact zone 308. The predicted impact zone 308 is associated with future movement of the one or more hazardous conditions.

Once the predicted impact zone 308 is generated by the analyzer 242 of FIG. 2, the communicator 244 of FIG. 2 may communicate an alert to one or more user devices located in the predicted impact zone 308. For example, the communicator 244 may receive the data associated with the predicted impact zone 308 from the analyzer 242 and communicate an alert to user devices (e.g., UE(s) 312 and/or IoT device(s) 334) located in first cell 324. In this example, the first cell 324 is located within the predicted impact zone 308. As depicted in the example illustrated in FIG. 3, the vulnerable homes 310 are located in the predicted impact zone 308 and are associated with any number of user devices, represented by UE 312 and IoT device 334. In the example, the communicator 244 may cause first base station 320 (e.g., the base station providing service to first cell 324) to send an alert to one or more user devices located in the vulnerable homes 310 to warn users residing in the vulnerable homes 310 that they may be in immediate danger (e.g., of a natural disaster, such as a tornado).

Furthermore, in some examples, when user devices within a vulnerable home 310 suddenly disconnect from the network, the predicted impact zone may be updated by the analyzer 242. As such, the analyzer 242 of FIG. 2 may periodically, intermittently, or continuously monitor the disconnections of user devices from networks as well as sensor and geographic data regarding the environment surrounding to form and refine the predicted impact zone. In the example illustrated in FIG. 3, the predicted impact zone may be refined to include a second cell 326. In some examples, when the user devices within a vulnerable home 310 suddenly disconnect from the network, the communicator 244 of FIG. 2 may cause first base station 320 to send the information associated with hazardous condition (e.g., represented by arrow 318) to a second base station 322 (e.g., servicing second cell 326), causing the second base station to send an alert to one or more user devices located in the susceptible homes 330 (e.g., represented by UE 332 and IoT device 336) to warn users residing in the susceptible homes 330 that they may be in immediate danger of the hazardous condition. As such, user devices in neighboring cells may receive alerts about the hazardous condition as the predicted impact zone is updated over time.

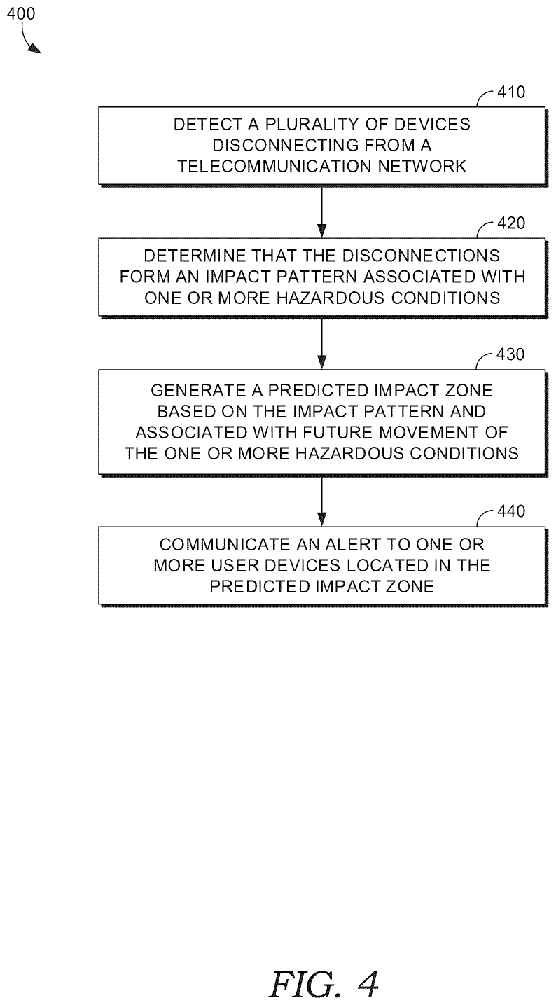

Turning now to FIG. 4, a flow chart representing a method 400 is provided. Generally the method 400 may be used by a base station, such as either the base station 202 or the base station 222 of FIG. 2, to alert user devices of anomalous behavior of UEs within a wireless communication system. At a first step 410, the base station detects a plurality of devices disconnecting from a telecommunication network, according to any one or more aspects described with respect to FIGS. 2-3. At a second step 420, it is determined that the disconnections form an impact pattern associated with one or more hazardous conditions, according to any one or more aspects described with respect to FIGS. 2-3. At a third step 430, a predicted impact zone is generated based on the impact pattern and associated with future movement of the one or more hazardous conditions, according to any one or more aspects described with respect to FIGS. 2-3. At a fourth step 440, the base station communicates an alert to one or more user devices located in the predicted impact zone, according to any one or more aspects described with respect to FIGS. 2-3.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for alerting user devices of anomalous behavior of user equipment (UE) within a wireless communication system, the system comprising:
one or more antenna elements configured to transmit one or more downlink signals from a base station to one or more UEs located in a geographic coverage area; and
one or more computer processing components configured to perform operations comprising:
detecting a plurality of devices disconnecting from a telecommunication network;
determining that the disconnections form an impact pattern associated with one or more hazardous conditions;
generating a predicted impact zone based on the impact pattern and associated with future movement of the one or more hazardous conditions; and
communicating an alert to one or more user devices located in the predicted impact zone.

2. The system of claim 1, wherein the plurality of devices comprises internet of things (IoT) devices and UEs.

3. The system of claim 2, wherein the one or more hazardous conditions comprises at least one natural disaster.

4. The system of claim 3, wherein the predicted impact zone further comprises a potential continued geographic path of the at least one natural disaster in the geographic coverage area.

5. The system of claim 1, wherein an artificial intelligence (AI) is used to determine that the disconnections form the impact pattern.

6. The system of claim 1, wherein an AI generates the predicted impact zone associated with future movement of the one or more hazardous conditions based on the detected pattern of anomalous behavior.

7. The system of claim 1, wherein communicating an alert to one or more user devices located in the predicted impact zone takes the form of a push notification.

8. The system of claim 1, wherein communicating an alert to one or more user devices located in the predicted impact zone takes the form of as SMS.

9. The system of claim 1, wherein communicating an alert to one or more user devices located in the predicted impact zone takes the form of a voice call.

10. The system of claim 1, wherein the alert causes the one or more user devices to perform an action without the user.

11. The system of claim 10, wherein the action is causing one or more lights to flash on the one or more user devices.

12. The system of claim 10, wherein the action is causing one or more speakers to sound an audible alert.

13. The system of claim 1, further comprising receiving an acknowledgement of the alert from the one or more user devices.

14. The system of claim 13, wherein the alert is recommunicated to the one or more user devices when it is not acknowledged.

15. A method for alerting user devices of anomalous behavior of user equipment (UE) within a wireless communication system, the method comprising:
detecting a plurality of devices in a geographic coverage area disconnecting from a telecommunication network;
determining that the disconnections form an impact pattern associated with one or more hazardous conditions;
generating a predicted impact zone based on the impact pattern and associated with future movement of the one or more hazardous conditions; and
communicating an alert to one or more user devices located in the predicted impact zone.

16. The method of claim 15, wherein the plurality of devices comprises internet of things (IoT) devices and UEs.

17. The method of claim 16, wherein the one or more hazardous conditions comprises at least one natural disaster.

18. The method of claim 15, wherein an artificial intelligence (AI) detects the pattern of anomalous behavior.

19. The method of claim 15, wherein an AI generates the predicted impact zone associated with future movement of the one or more hazardous conditions based on the detected pattern of anomalous behavior.

20. A non-transitory computer readable media having instructions stored thereon that, when executed by one or more computer processing components, cause the one or more computer processing components to perform a method for alerting user devices of anomalous behavior of user equipment (UE) within a wireless communication system, the method comprising:
detecting a plurality of devices in a geographic coverage area disconnecting from a telecommunication network;
determining that the disconnections form an impact pattern associated with one or more hazardous conditions;
generating a predicted impact zone based on the impact pattern and associated with future movement of the one or more hazardous conditions; and
communicating an alert to one or more user devices located in the predicted impact zone.
